(19) United States
(12) Patent Application Publication
(10) Pub. No.: US 2003/0189579 A1
(43) Pub. Date: Oct. 9, 2003

(54) Adaptive enlarging and/or sharpening of a digital image

(76) Inventor: David R. Pope, Milpitas, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/117,979

(22) Filed: Apr. 5, 2002

(51) Int. Cl. G09G 5/00

(52) U.S. Cl. 345/660

(57) ABSTRACT

The invention relates to enlarging and/or sharpening a digital input image into a resized and/or sharpened digital output image, where the enlargement technique is performed in accordance with the input image content. An enlarged approximated version of an original image is combined with a residual image to produce an output image of desired size. The approximated image is computed by a two-dimensional (2-D) approximation. The residual image is the same size as the original image, or may be enlarged to the size of the desired output image. The residual image data is selectively added to the approximated image such that image information is added everywhere in the image except at continuous edges.

### BACKGROUND OF THE INVENTION

1. Field of the Invention

The present invention relates to graphical image processing and, more particularly, to enlarging and sharpening digital images.

2. Description of the Related Art

Image resizing, such as digital zoom, is a common task in digital image processing. The most commonly used methods of resizing rely on interpolation. Techniques such as fuzzy logic, inter-resolution look-up tables, fractals, and intentional blurring along lines after interpolation have also been used. Current methods face difficulty when the enlargement ratio desired is larger than 2 (two). Image enlargement by interpolation involves mapping pixels in an original image to an enlarged image in which the original image pixels are spaced farther apart in the enlarged image and the intensity values of intervening pixels are determined through interpolation of the original image pixel intensities.

While interpolation algorithms, such as bi-cubic or bilinear techniques, can produce images that are visually pleasing over most of the image area, at or near high contrast edges there are at least three objectionable problems. The first of these problems is “blockiness” or jaggedness at high contrast diagonal (not horizontal or vertical) edges. The second problem is ringing, or overshoot and undershoot at high contrast edges. The third problem with resizing by interpolation is the blurring of what should be a near step-change in luminance into a more gradual transition.

These problems with interpolation techniques can be minimized by carefully selecting the interpolation coefficients, or by blending the images resulting from multiple interpolation methods. For example, U.S. Pat. No. 5,327,257 describes a method in which enlarged images obtained by both a “sharp” interpolation method and a “soft” interpolation method are blended using local image characteristics to determine the relative contribution of each image. This technique can successfully eliminate the ringing at high contrast edges, but it can worsen the blur at the same edges compared to using only the sharp interpolation, and will not eliminate the jaggedness, which is generally regarded as more disturbing than the ringing.

No interpolation technique can eliminate the jaggedness at high contrast diagonal edges. While different interpolation techniques will return differing pixel values for the new pixels in an enlarged image, they will all return the same values for the pixels in the original image. Interpolation algorithms estimate new values for pixels in an enlarged image that lie between values for known pixels, and do not alter the original pixel values. Stated in another way, as an interpolated pixel location gets closer to an original pixel location, the value of the interpolated pixel is more and more constrained by the value of only the nearby original pixel. At high contrast diagonal edges, this causes jaggedness.

Image sharpening is normally a separate procedure, performed independently of any enlargement processing. By tailoring the image sharpening to the amount of enlargement and with the knowledge of where the most blurring is introduced in the enlargement process, a much improved result can be achieved.

One common technique used to sharpen images is called unsharp masking. Unsharp masking is effectively an extrapolation of an image to be sharpened away from a blurred version of the image. The technique does result in a sharper image, but has several drawbacks. At high contrast edges, unsharp masking results in overshoots and undershoots. This is particularly true with larger operator (enlargement) sizes, which would be required for enlargement factors greater than 200%. Unsharp masking also tends to amplify any noise in the image and make any artifacts in the image more visible.

From the discussion above, it should be apparent that there is a need for improved enlarging and sharpening of digital images. The present invention fulfills this need.

### SUMMARY OF THE INVENTION

The present invention is directed to enlarging and sharpening of digital images. In accordance with the invention, an enlarged approximated version of an original image is combined with a residual image to produce an output image of desired size, or enlarged resolution. Every pixel in the enlarged approximated image is computed by a two-dimensional (2-D) approximation, rather than an interpolation. The 2-D approximated image will generally be less sharp than an image that is enlarged by a bi-cubic interpolation technique, but it should not have the problems of severe ringing or jaggedness. The residual image is the pixel intensity difference between pixels in the approximated image and corresponding pixels in the original image. When computed, the residual image is the same size as the original image, but may be enlarged to the size of the desired output image. Combining the residual image with the approximated image adds information contained in the residual image that returns the detail (sharpness) that might have been lost in the 2-D approximation process. In accordance with the invention, the residual image data is selectively added to the approximated image such that image information is added everywhere in the image except at continuous edges. The residual information is preferably added to the approximated image in accordance with a continuous function, to avoid artifacts such as jaggedness and overshoot and undershoot. In this way, the present invention provides techniques to both enlarge and sharpen digital images with artifact-free output images that retain or even enhance their details, but do not accentuate image noise.

Other features and advantages of the present invention should be apparent from the following description, which illustrates, by way of example, the principles of the invention.

### BRIEF DESCRIPTION OF THE DRAWINGS

FIG. 1 is a flow diagram that illustrates image processing performed in accordance with the present invention.

FIG. 2 is a flow diagram of the preferred embodiment, including an image enlargement stage and two image sharpening stages.

FIG. 3 is a graphical illustration of the lookup table used in the improved unsharp masking algorithm to map a local gradient to an extrapolation factor.

FIG. 4 is a graphical illustration of the effects of limiting the overshoots inherent in unsharp masking.

FIG. 5 is a graphical illustration of the effects of the second sharpening technique.

FIG. 6 is a block diagram representation of an image capture device constructed in accordance with the present invention.

FIG. 7 is a block diagram representation of a computing device constructed in accordance with the present invention.

### DETAILED DESCRIPTION

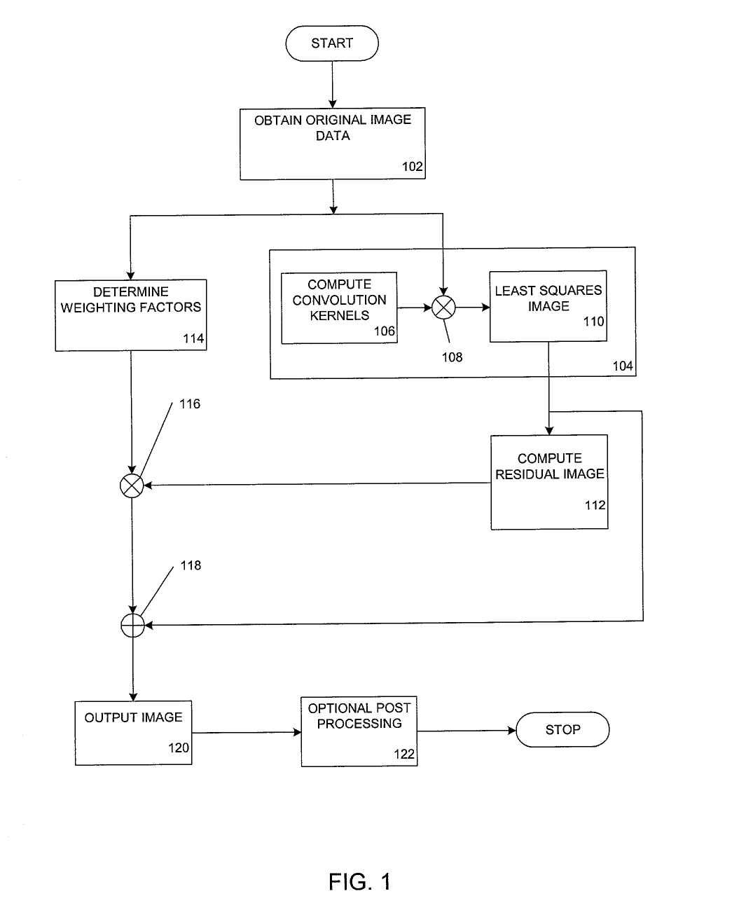

FIG. 1 shows a flow diagram that illustrates image processing that is carried out in accordance with a preferred embodiment of the present invention. The invention can advantageously be implemented on a computing device that is associated with a display, to permit observation of the processing results, and can be performed in real time. Real time operation permits a user to contemporaneously observe the results of the image processing performed in accordance with the invention and to make any changes or modifications to the output image, as desired. The invention may also be implemented in an image capture device, such as a digital camera, as well as a computing device such as a personal computer or graphics workstation. The technique may be used for image resizing, including enlargement and reduction in resolution. The preferred embodiment will be described in the context of image enlargement, but those skilled in the art will be able to understand the description below and identify how the described features and operation can be applied to image reduction.

Operation in Accordance With the Invention

In the first operation, represented by the FIG. 1 flow diagram box numbered 102, processing begins with original input image data. The original input image comprises digital data that specifies pixel intensities of an image. The input image may comprise, for example, what is known as a bitmap image and may specify a resolution of 800×600 pixels. Each pixel of the image data corresponds to a point on an output display, such as a video display, flat panel device, or printer output. A typical display, for example, includes pixels with a diameter of 0.29 mm.

Those skilled in the art will understand that conventional image enlargement often occurs by interpolation, which involves mapping pixels in an original image to an enlarged image in which the original image pixels are spaced farther apart in the enlarged image and the intensity values of intervening pixels are determined through interpolation of the original image pixel intensities. For example, the image resolution or image size will double if pixels that were adjacent in the original image are now separated by one intervening pixel in the enlarged image. A similar resizing involving removal of pixels may occur for image reduction. Typically, the input image referenced in box 102 is obtained from data storage or is received from the output of an image capture device. In the next operation, an approximated image is computed from the original input image. Computing the approximated image is represented by the flow diagram box numbered 104.

In the preferred embodiment, the approximated image has an image size that corresponds to the desired size of the output image. In general, it is preferred that the approximated image is as close as practical to the final output size, so that no additional resizing is needed later in the processing operations. Every pixel in the enlarged approximated image is computed by a two-dimensional (2-D) approximation. This avoids using an interpolation technique, which typically has unpleasant artifacts associated with high contrast edges. Alternatively, the approximated image may have a size different from that of the desired final output size. In that situation, the computation of the approximated image will be easier if the enlargement ratio of the approximated image is an integer ratio. If a non-integer ratio of enlargement is desired, then the approximated image may be enlarged to the nearest integer ratio and then additional resizing may be performed to obtain the desired image size, in accordance with conventional techniques that will be known to those skilled in the art.

FIG. 1 shows that, in a preferred embodiment, the approximated image is computed using convolution kernels that are computed in an operation represented by the box numbered 106. The convolution kernels (preferably for a least squares approximation) are applied to the original image data, as represented by the multiplication operator 108. The image produced from the applied convolution kernels is the enlarged approximated image, indicated by the flow diagram box numbered 110.

In the next operation, a residual image is determined. This operation is represented by the flow diagram box numbered 112. Each pixel of the residual image comprises the pixel intensity difference between a pixel in the original image and a corresponding pixel in the approximated image. The residual image therefore is the same size as the original image, but it may be enlarged to the size of the desired output image. Enlarging the residual image to the output image size generally provides an improved quality output image and simplifies processing for the combining operation, described further below.

The residual image may be enlarged using a variety of techniques, such as interpolation techniques. For example, it has been found that bi-cubic interpolation works well to enlarge the residual image. Using the residual image at the original image size, without enlargement, is equivalent to using a nearest neighbor interpolation technique.

In addition to using the original input image to produce an enlarged approximated image and the residual image, the input image is also used to compute a set of weighting factors, W. This operation is represented by the flow diagram box numbered 114. The weighting factors govern how the residual image is combined with the enlarged approximated image to produce the output image in accordance with the invention. As described further below, the weighting factor for each pixel is computed based on local image characteristics of the original image. For example, each weighting factor may be computed from a luminance channel of the original image, and the same weighting factor value may be used for all channels associated with the image. Those skilled in the art will be familiar with luminance channel information and other channels associated with a digital image. In addition, each weighting factor may be determined in accordance with a local gaussian curvature value for the corresponding original image pixel, or further in accordance with a local gaussian curvature value and a local image gradient for the corresponding original image pixel. Computational procedures for determining the weighting factors are described further below.

After the weighting factors are determined at box 114, the weighting factors are used to selectively combine pixels of the residual image with pixels of the enlarged approximated image. That is, the weighting factors provide a means of selectively adding information from the residual image to the approximated image, such that image information is added everywhere in the approximated image except at continuous edges. The residual information is preferably added to the approximated image in accordance with a continuous function, as described further below, to avoid artifacts. The resulting combined image, the output image of desired enlargement, may then be viewed on a display device or printed on an output surface such as paper stock, or may be stored for later retrieval and display or printing.

To selectively combine the residual image information with the approximated image, the preferred embodiment combines the weighting factors with the residual image data, as represented by the multiplication operator 116. A different weighting factor may be determined for each pixel of the residual image. The processed (weighted) residual image is then combined with the approximated image. This operation is represented by the addition operator 118. It should be apparent that any weighting factor of zero, applied to a pixel of the residual image, will effectively eliminate that residual image pixel from being added into the approximated image. In this way, pixels of the residual image are selectively added into the approximated image at the operator 118 to produce the output image at box 120.

An optional post processing phase may be implemented to further enhance the output image produced in accordance with the invention. The post processing is represented by the flow diagram box numbered 122.

In one aspect of the optional post processing of box 122, any sharpness that was lost in producing the approximated image is restored in a modification procedure that sharpens the enlarged output image along high contrast edges. The modification procedure preferably involves an unsharp masking procedure and a local histogram modification procedure. In this way, the enlarged image is processed serially by two algorithms that together achieve a sharp and pleasing image.

The unsharp masking technique in accordance with the invention is a technique that limits overshoots and undershoots and does not amplify the noise in the image to be sharpened. Overshoots and undershoots are limited by searching an area around the pixel to be modified for maximum and minimum intensities and bringing any modified pixel value outside the range between the maximum and the minimum back towards the range. The size of the search area is a function of either the enlargement ratio or the amount of blur used in the unsharp mask algorithm. The modification that limits noise, while sharpening image detail, varies the amount of sharpening for each pixel based on the image gradient at that pixel, using a lookup table.

The second post processing sharpening technique is applied mainly at high contrast continuous edges, where little of the residual image is added back in and where blur is the most apparent to the human visual system. The second algorithm is a local histogram modification technique in which intermediate pixel values are remapped towards the dark or light extremes of the blurred edge. The result is a sharper edge profile.

Thus, the preferred embodiment, which utilizes the post processing techniques, comprises a two-pronged approach to achieving high-quality digitally enlarged images. It has been found that the unsharp masking and local histogram modification provide superior final images, and these operations are used in the preferred embodiment. Similarly, resizing the residual image to the output image size is optional, but provides superior results and is performed by the preferred embodiment. First, a weighted combination of the 2-D least-squares approximation and its residual image is used to enlarge the image with minimal artifacts. Then, two sharpening algorithms that depend on the scale factor to reduce the blurriness follow the enlargement step. The end result is an enlarged, sharp image with minimal artifacts.

Processing of an original input image in accordance with the invention as described above permits enlarging and sharpening digital images with artifact-free output images that retain or even enhance their details, but do not accentuate image noise.

Optional Operations

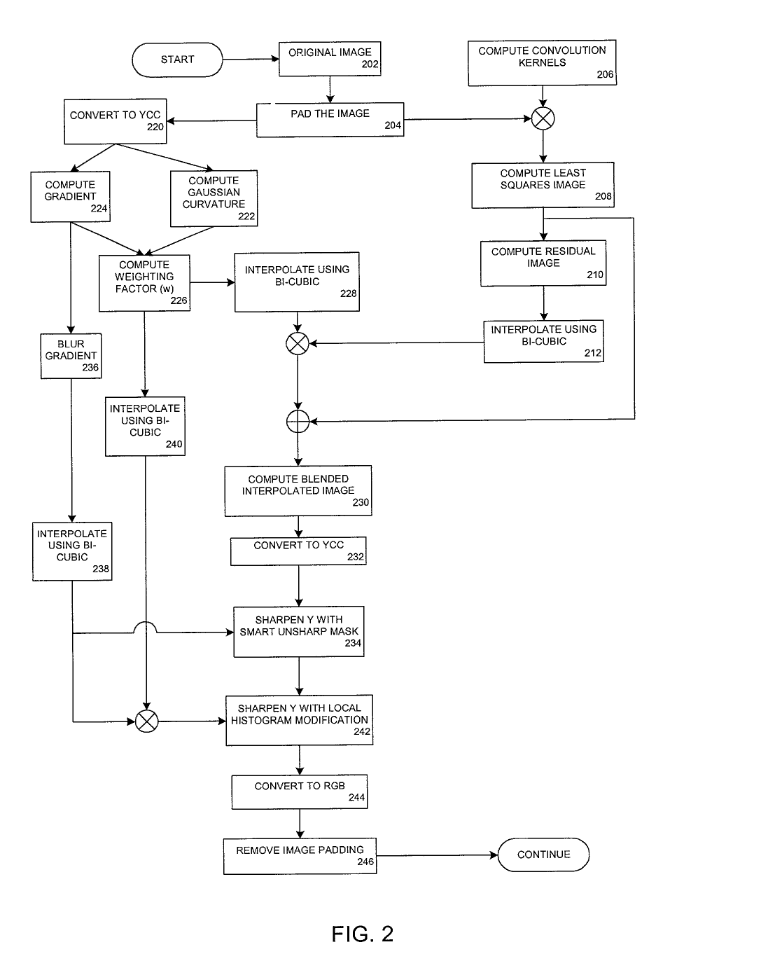

Additional processing may be performed to further enhance the output images obtained in accordance with the invention. These operations, as well as other details of processing in accordance with a preferred embodiment of the invention, are described with reference to FIG. 2, which shows processing that is especially suited to a digital zoom image.

Image processing in accordance with the invention begins with an original digital image, indicated at the flow diagram box numbered 202. The next operation in the digital image processing is to pad the original input image, as indicated at box 204. This is performed to prevent image boundary effects in the processing stages from affecting the final image. In the preferred embodiment, mirroring the image at each boundary is the method used to pad the image. The image boundary, for a quadrilateral image, is defined with boundary (1) as the top edge, boundary (2) as the bottom edge, boundary (3) as the left vertical edge, and boundary (4) as the right vertical edge. The padding effectively creates a border around the image boundaries and will be removed after the various processing operations are performed.

As noted above, the 2-D least-squares approximation can advantageously be performed by convolution if the scaling factor (enlargement ratio) is an integer value, the same sub-pixel locations (relative to each original pixel) are to be approximated for each pixel interval in the original image. For example, for a scaling factor or resolution enlargement of 2.0, the locations would be: (0, 0), (0.5, 0),

(0, 0.5), and (0.5, 0.5). Each sub-pixel location needs its own convolution kernel, but once the kernel is computed (indicated at box 206), the approximated value for that relative location can be computed for every pixel interval in the original image by convolution (indicated by the summing operator). Those skilled in the art will understand details of how such approximated values may be computed.

Prior to performing the 2-D least-squares approximation at box 208, the convolution kernels are pre-computed, as indicated at box 206. In the preferred embodiment, only integer multiples of the resolution will be computed in this manner, so that the pre-computed kernels can be reused at each location in the original image. If a non-integer scaling factor is desired, the image will be enlarged up to the next highest integer multiple of the desired resolution, and then resampled back down to the desired final resolution using bi-cubic interpolation. An 8×8 fifth-order convolution kernel is computed for each (dx, dy) combination (each approximated pixel). For example, for a four-times expansion in each direction, sixteen convolution kernels are needed, because the resolution increases by a factor of four squared and the (dx, dy) combinations are (0, 0), (0, 0.25), (0, 0.5), . . . , and (0.75, 0.75).

In the preferred embodiment, the weighted least squares convolution kernels are computed using Equation (1) below:

u=(A^{T}WA)⁻¹A^{T}Wz (1)

where assuming a fifth order fit and an 8×8 kernel,

$$A = [ \begin{matrix}{φ}_{1} ( {x}_{1} , {y}_{1} ) & {φ}_{2} ( {x}_{1} , {y}_{1} ) & ⋯ & {φ}_{m} ( {x}_{1} , {y}_{1} ) \\ {φ}_{1} ( {x}_{2} , {y}_{2} ) & {φ}_{2} ( {x}_{2} , {y}_{2} ) & ⋯ & {φ}_{m} ( {x}_{2} , {y}_{2} ) \\ ⋯ & ⋯ & ⋯ & ⋯ \\ {φ}_{1} ( {x}_{n} , {y}_{n} ) & {φ}_{2} ( {x}_{n} , {y}_{n} ) & ⋯ & {φ}_{m} ( {x}_{n} , {y}_{n} )\end{matrix} ]$$

φ₁=1,φ₂=x,φ₃=y,φ₄=x²,φ₅=xy, . . . ,φₘ₋₁=xy⁴,φₘ=y⁵

if

f(x, y)≈μ₁φ₁+μ₂φ₂+ . . . +μₘφₘ

then:

$$u = [ \begin{matrix}{μ}_{1} \\ {μ}_{2} \\ ⋮ \\ {μ}_{m}\end{matrix} ]$$

with one column for each (x, y) combination.

Those skilled in the art will understand that Equation (1) is derived using a Moore-Penrose inverse found by singular value decomposition.

In the above Equation (1), the vector z is of length n and contains the pixel intensities that will be used in the approximation, and W is an n x n matrix containing the weighting factors of the error components. The weights are from a gaussian distribution with a standard deviation (SD) of one pixel to prevent any ringing in the image. Those skilled in the art will understand that, for a fifth order fit, m=21 and, for an 8×8 kernel, n=64. Combinations (x₁, y₁), (x₂, y₂), . . . , and (x_{n, y}ₙ) are the x and y positions, respectively, of the 8×8 pixels in the original image, relative to the chosen origin, and are used to approximate the desired pixel in the least-squares approximated image.

If the origin is chosen to coincide with the location of the pixel to be approximated, only the constant part of the column vector u (μ₁) is needed, since x and y will be zero for that point. The n=64 values in the first row of the matrix (A^{T}WA)⁻¹A^{T}W becomes the 8×8 convolution kernel. One convolution kernel needs to be computed for each (dx, dy) combination. For a scaling factor of four, sixteen convolution kernels are needed. The sixteen convolution kernels can be pre-computed at box 206 and used repeatedly to compute the least-squares approximated image.

Each convolution kernel is multiplied pixel by pixel with the same eight by eight patch of the Red, Green, Blue (RGB) data in the original image to approximate the pixel intensity for all (dx, dy) combinations, thereby producing the approximated image. Using a 6×6 kernel instead of an 8×8 kernel can, depending on the convolution method, improve the speed. The smaller kernel, however, does not perform as well on diagonal edges, and some ringing may be evident.

Once the least-squares approximated image is computed at box 208, a residual image is computed, as indicated at box 210. If the enlargement is accomplished by interpolation and not least-squares approximation, then every n point would have the same intensity as the corresponding point in the original image, where n is the integer scale multiplier. This is because in interpolation, unlike approximation, the fitting functions are constrained to pass through the original pixel points. The least-squares image produced in accordance with the invention does not have this constraint.

The residual image, which will be the same size as the original scale padded image, is computed by taking the difference between the original pixel value and the approximated pixel value of the corresponding point. This image is then enlarged by the desired multiplication (enlargement) factor using bi-cubic interpolation. The interpolation operation is indicated by the flow diagram box numbered 212.

It has been found that, to obtain a suitable enlarged image, at each pixel a fraction (which depends on a weighting factor computed using local image characteristics) of this residual image is added to the least-squares approximated image. The weighting factor should indicate the presence of continuous edges, since continuous edges are what can lead to artifacts. It has been found that a combination of the gaussian curvature and the gradient of the image performs well in indicating the presence of continuous edges.

In the preferred embodiment, the first step in computing the weighting factor is to convert the original sized padded image (typically in RGB color space) into YCC space, a luminance-chrominance color space known to those skilled in the art. The YCC conversion is indicated by the flow diagram box numbered 220. The purpose of this operation is to obtain one weighting factor that will be applied to the three channels of the color image. The weighting factor will be computed using the Y, or luminance, channel of the YCC image. Any combination of the RGB channels that approximates luminance can be used to produce the YCC image. The following equation, Equation (2), based on the National TV Standards Committee (NTSC) primaries, is used for the YCC conversion:

$$[ \begin{matrix}Y \\ C b \\ C r\end{matrix} ] = [ \begin{matrix}0.2989 & 0.5866 & 0.1145 \\ - 0.1687 & - 0.3312 & 0.5000 \\ 0.5000 & - 0.4183 & - 0.0816\end{matrix} ] [ \begin{matrix}R \\ G \\ B\end{matrix} ] \qquad ( 2 )$$

If the starting RGB values are sRGB, then the ITU-R BT.709-2 primaries should be used. The equation for sRGB is given by Equation (3):

$$[ \begin{matrix}Y \\ C b \\ C r\end{matrix} ] = [ \begin{matrix}0.2126 & 0.7152 & 0.0722 \\ - 0.1146 & - 0.3854 & 0.5000 \\ 0.5000 & - 0.4542 & - 0.0458\end{matrix} ] [ \begin{matrix}R \\ G \\ B\end{matrix} ] \qquad ( 3 )$$

Once the Y-channel image is obtained, the gaussian curvature at each pixel is computed using a finite difference technique shown in Equation (4).

$$\begin{matrix}C1 ( x , y ) = \frac{Z x x ( x , y ) * Z y y ( x , y ) - {Z}^{2} x y ( x , y )}{{( 1 + {Z}^{2} x ( x , y ) + {Z}^{2} y ( x , y ) )}^{2}} \\ W he r e Z x ( x , y ) = \frac{Z ( x + 1 , y ) - Z ( x - 1 , y )}{2} \\ Z y ( x , y ) = \frac{Z ( x , y + 1 ) - Z ( x , y - 1 )}{2} \\ Z x x ( x , y ) = Z ( x + 1 , y ) - 2 * Z ( x , y ) + Z ( x - 1 , y ) \\ Z y y ( x , y ) = Z ( x , y + 1 ) - 2 * Z ( x , y ) + Z ( x , y - 1 ) \\ Z x y ( x , y ) = \frac{Z ( x + 1 , y + 1 ) + Z ( x - 1 , y - 1 ) - Z ( x + 1 , y - 1 ) - Z ( x - 1 , y + 1 )}{4}\end{matrix} \qquad ( 4 )$$

The gaussian curvature computation is indicated by the flow diagram box numbered 222. Prior to computing the finite differences, each pixel intensity value, Z, is divided by two. This is to adjust for the different scales of the three dimensions. The values x and y denote distances, but Z is a measure of intensity. Dividing by two has been found to achieve the desired results of near zero values at sharp edges and higher values elsewhere in the image.

The values of the gaussian curvature cover a very wide range, with relatively few pixels obtaining high values. To compress the range, the base-10 logarithm of each value plus one is computed, and a typical image is scaled from zero to approximately twenty for pixel intensity values. These operations are shown in Equation (5).

C(x, y)=20*log₁₀(C1(x, y)+1)/3.2 (5)

The Equation (5) denominator value of 3.2 has been found to yield pleasing results. Similar values should produce similar results and alternative values may be determined by experimentation according to individual preference. At this point, the gaussian curvature image is blurred by convolving with a gaussian (SD=1) to smooth it out. Any resultant value greater than one is clipped to one. All of these operations are represented by the FIG. 2 flow diagram box numbered 222.

In the preferred embodiment, a gradient image is computed by convolving the Y (intensity) image with both a horizontal (H) and a vertical (V) Prewitt operator, shown in Equation (6):

$$H = [ \begin{matrix}- 1 & - 1 & - 1 \\ 0 & 0 & 0 \\ 1 & 1 & 1\end{matrix} ] V = [ \begin{matrix}- 1 & 0 & 1 \\ - 1 & 0 & 1 \\ - 1 & 0 & 1\end{matrix} ] \qquad ( 6 )$$

Those skilled in the art will be familiar with other alternative gradient detectors that would provide a suitable result. The gradient computation is represented by the flow diagram box numbered 224.

A single gradient value at each pixel is computed by taking the square root of the sum of the squares of the vertical and horizontal gradient values. The gradient image is then scaled by dividing each value by 530.00 and clipping the resulting number to 1 (one). Any scaled value less than 0.07 is set to be equal to 0.07. The number 530.00 has been found to be about the largest gradient value found in typical images. The gradient computation process is represented by box 224.

A weighting factor (w) is determined by computing the ratio of the squares of the gaussian curvature and gradient values, as shown in Equation (7) below. Computation of the weighting factor is represented in FIG. 2 by the flow diagram box numbered 226.

$$w ( x , y ) = {log}_{10} ( \frac{{C ( x , y )}^{2}}{Grad {( x , y )}^{2}} ) / 2.3 \qquad ( 7 )$$

Any value of w greater than one is clipped to one. Near-zero values of w are achieved at high contrast edges, where the gaussian curvature is small and the gradient is large. If both the gaussian curvature and the gradient are small, the image region is very smooth and very little information will be contained in the residual image rendering the value of w unimportant. Because of the floor put on the value of the gradient, a ceiling is placed on the value of the weighting factor. If both the gaussian curvature and the gradient are large, the weighting factor will be larger than the case of a high contrast edge. The final case, where the value of the gaussian curvature is large and the gradient is small (large w) would indicate fine details, where all of the information in the residual image should be added back in. The computation of weighting factors is indicated by the box numbered 226.

The resized (enlarged) image (I) is a combination of the least-squares (LS) image and the residual image (R). They are combined using the weighting factor (w) from box 226 by the following equation, Equation (8):

I(x, y)=LS(x, y)+w(x, y)*R(x, y) (8)

Combining the weighting factor with the residual image data is represented by box 228 and the multiplication operator, and combining with the least squares image data is represented by the summing operator. The technique described above results in a smooth, reasonably detailed image at box 230; but the blended, interpolated image is one that is undeniably blurry. This is particularly true at the high contrast edges, where the enlargement contains information from only the least-squares approximation. Since both the cause of the blur and image locations where the blur is the worst (small w) are known, a good sharpening technique was determined for application to the resized image.

The second part of the preferred operation in accordance with the invention includes two image-dependent sharpening techniques, applied serially. The first sharpening technique is a modification of the commonly used unsharp masking technique. The second sharpening technique is a local histogram modification method.

In order to reduce the computational time and to minimize any color changes, both sharpening algorithms are applied to only a luminance channel Y. Conversion of the image to be sharpened into YCC space is performed at box 232. Equation (2) or (3) may be used to convert from RGB to YCC. After sharpening the Y channel, the image is converted back to RGB space using either Equation (9):

$$[ \begin{matrix}R \\ G \\ B\end{matrix} ] = [ \begin{matrix}1.0000 & 0.0000 & 1.4022 \\ 1.0000 & - 0.3456 & - 0.7145 \\ 1.0000 & 1.7710 & 0.0000\end{matrix} ] [ \begin{matrix}Y \\ C b \\ C r\end{matrix} ] \qquad ( 9 )$$

for NTSC primaries, or Equation (10):

$$[ \begin{matrix}R \\ G \\ B\end{matrix} ] = [ \begin{matrix}1.0000 & 0.0000 & 1.5748 \\ 1.0000 & - 0.1873 & - 0.4681 \\ 1.0000 & 1.8556 & 0.0000\end{matrix} ] [ \begin{matrix}Y \\ C b \\ C r\end{matrix} ] \qquad ( 10 )$$

for ITU-R BT.709-2 primaries.

In the preferred embodiment, the unsharp masking operation is performed at box 234 by extrapolating away from a blurred version of the image to be sharpened. The first step is to blur the enlarged image. This is preferably achieved by convolving the enlarged image with a gaussian of standard deviation equal to half the image enlargement factor, and a kernel size of plus and minus four standard deviations. The extrapolation is computed using the following Equation (11):

S(x, y)=B(x, y)+α(x, y)*(I(x, y)−B(x, y)) (11)

wherein S is the sharpened image, I is the enlarged image, B is the blurred version of the enlarged image and a controls the sharpening. If a is less than one, Equation (9) will result in a blurred version of I. If, however, α is greater than one, S is extrapolated away from the blurred image and the resultant image is sharper. In most unsharp masking routines in the prior art, α is a constant value if some threshold condition in the image is met. That is not the case in the present invention.

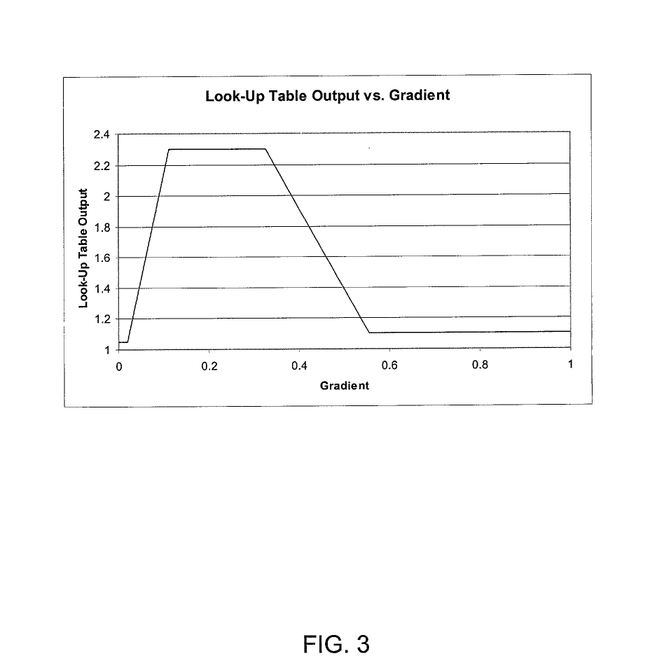

The value of α is computed for each pixel in the image to be sharpened. The first step in computing a is to blur the gradient map computed for the resizing algorithm. This is indicated at the flow diagram box numbered 236. In the preferred embodiment, the blurring is performed by convolving with a gaussian standard deviation equal to 1 (one). Next, the blurred gradient map is resized using bi-cubic interpolation up to the size of the image to be sharpened, as indicated at box 238. The blurred gradient value at each pixel is then mapped using a look-up table to a value of α. For very low gradient values, little or no sharpening is desired and a is set to near 1 (one). The value of α then increases linearly as the gradient value increases up to a maximum value. A range of gradient values map to the highest value of α; but above a cutoff value, α decreases linearly down to a minimum value as the gradient increases. An example look-up table of gradient values versus output values is shown in FIG. 3.

Computing α in this manner has the effect of sharpening the edges and texture of the image without accentuating image noise. It also avoids many artifacts that are visible when applying a standard unsharp mask. The operation of unsharp masking with the blurred interpolated gradient image and a processing is represented by box 234.

One problem with unsharp masking often remains: overshoot. An unsharp mask can result in severe overshoot at sharp edges. This is most apparent when an image transitions from a light gray region to a dark gray region at a step edge. If unsharp masking is applied, on the light side of the edge the overshoot will cause a white line, and on the dark gray side it will cause a black line. If strong unsharp masking is applied, the overshoot can be quite disturbing.

In accordance with the preferred embodiment, the first step in minimizing any overshoot is to find minimum and maximum pixel values surrounding the pixel to be modified. When sharpening an enlarged image, the size of the range to be searched is a function of the scale factor of the image. Otherwise, it is a function of the amount of blur in the blurred version of the image. It has been found that a good search range to use is plus and minus the scale factor around the pixel to be modified, or twice the standard deviation of the gaussian used to blur the image. If the pixel value returned by the unsharp mask algorithm is outside the range of the maximum and the minimum, it is adjusted most of the way back to the minimum or the maximum. It has been found that a value of about 85% provides useful and pleasing results. Overshoots can be eliminated by reducing the value all the way back to the local maximum or minimum at the cost of flat, unchanging regions of the image near edges and a slight loss in apparent sharpness.

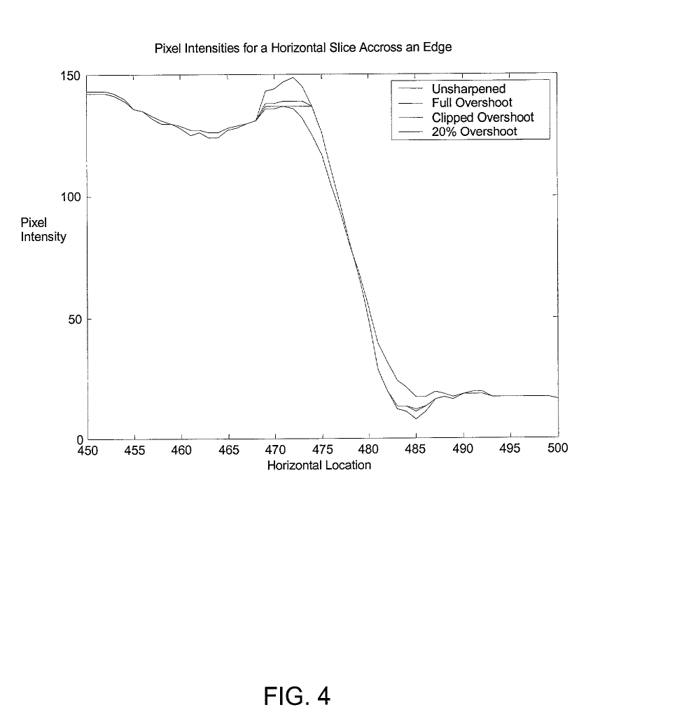

FIG. 4 demonstrates the effect of limiting the overshoot in this way. It shows the pixel intensity values for a horizontal slice through a high contrast edge of a digital photograph that has been enlarged by a factor of 6 in each direction. Three levels of overshoot are shown, 0%, 20%, and 100%. For all levels of overshoot, the edge gradient is increased by the same amount.

Thus, improved image sharpening in accordance with the present invention involves sharpening the resized output image by computing a gradient image for the original input image and extrapolating the intensity of each resized image pixel away from a blurred version of the resized image. Preferably, the extrapolation is performed in accordance with a corresponding gradient value, thereby producing a sharpened image, and then for each pixel in the unsharpened image searching the image area surrounding the pixel and finding the maximum and minimum pixel intensity value in the searched area, wherein the size of the area to be searched is a function of the resolution factor of the resized output image in comparison with the original input image. Lastly, the improved sharpening involves, for each pixel in the sharpened image produced from extrapolating the pixel intensity, comparing the intensity value of a sharpened image pixel to the corresponding maximum and minimum intensity values found in pixels of the unsharpened image from the search operation, and modifying the intensity value of the sharpened image pixel in response to the comparison. Thus, pixel intensity values are identified where the intensity value of the sharpened pixel is outside the range of the maximum and the minimum intensity values found in the unsharpened image, and then the sharpened intensity values are modified to be closer to the nearer of the maximum or the minimum of the found intensity values.

The process can be described as follows for the case where the sharpened intensity values are less than the minimum values:

The sharpened image is modified by identifying when the value of the sharpened pixel is greater than the maximum intensity value, and modifying the sharpened pixel intensity value to a value given by F(x, y), wherein F(x, y) is specified according to the relationship of Equation (12):

F(x, y)=max(x, y)+a*[S(x, y)−max(x, y)], (12)

wherein F(x, y) is the final sharpened pixel intensity value, min(x, y) is the minimum intensity value found for that pixel location, a is a value that specifies the fraction of the overshoot to allow, and S(x, y) is the value of the sharpened pixel intensity. As noted above, it is noted that a=0.15 [that is, (1−0.85) adjustment] has been found to provide good results, but other values may be utilized, depending on the desired effect and characteristics of the image.

The process can be described as follows for the case where the sharpened intensity values are less than the minimum values:

The sharpened image is modified by identifying when the value of the sharpened pixel is less than the minimum intensity value, and modifying the sharpened pixel intensity value to a value given by F(x, y), wherein F(x, y) is specified according to the relationship of Equation (13):

F(x, y)=min(x, y)+a* [min(x, y)−S(x, y)], (13)

wherein F(x, y) is the final sharpened pixel intensity value, min(x, y) is the minimum intensity value found for that pixel location, a is a value that specifies the fraction of the overshoot to allow, and S(x, y) is the value of the sharpened pixel intensity. As before, it is noted that a=0.15 [an adjustment of (1−0.85)] has been found to provide good results, but other values may be utilized, depending on desired effect and characteristics of the image.

These modifications to unsharp masking result in a much-improved process for producing output images. The process is useful on any image that is in need of sharpening, whether or not it has been enlarged by the operations described in accordance with the present invention.

The unsharp masking performs well for sharpening the overall image, but does not necessarily reduce the blur in the enlarged image enough at high contrast edges. This is partially because the high contrast edges are enlarged using only the least-squares fit and partially because the human visual system is very sensitive to blur at high contrast edges. A highly specific sharpening technique is desired for the high contrast edges in enlarged images.

Since an edge map (referred to as the weighting factor previously) and a gradient map have already been computed, applying a sharpening routine only to the edges can be achieved for relatively little computational cost. The method selected is a form of local histogram modification. The local histogram modification pushes the pixel values at edges towards the brightest or darkest neighboring pixels, which has the effect of sharpening edges.

A weighting factor that will scale the effects of the local histogram modification routine is a modification to the weighting factor computed earlier for the enlargement. The new weighting factor (W) is computed with the following equation, Equation (14):

W(x, y)=2*(1−w(x, y))*Grad(x, y) (14)

wherein W is the new weighting factor, w is the weighting factor computed in the enlarging stage (from box 226) and G is the gradient map computed in the smart unsharp masking stage. Any values higher than one are clipped to one. Most pixels in the image should have a W value close to zero (not edge pixels). The calculation of the new weighting factor W is represented by box 240, and the combining with the gradient image from box 236, 238 processing is represented by the flow diagram box numbered 242.

The histogram modification is applied to any pixel with a W value greater than a threshold value (0.2 to 0.3 preferably). When such a pixel is located, a square region (plus and minus half the scale factor from the pixel to be modified) is searched for other pixels with a suprathreshold value of W. Both the maximum and the minimum intensity values (Y) of these pixels are determined.

The maximum and minimum intensity values of the surrounding pixels are used to compute a new intensity value for the pixel to be modified. A logistic function is used to map the pixel intensity to a new intensity. The function used is given by Equation (15):

$$S ( x , y ) = x Min ( x , y ) + a * \frac{1}{1 + {ⅇ}^{\frac{I ( x , y ) - Mid}{B}}} \qquad ( 15 )$$

where

$$Mid = \frac{x Max ( x , y ) + x Min ( x , y )}{2} ,$$

a=xMax(x, y)−xMin(x, y),

and

$$B = \frac{x Max ( x , y ) - x Min ( x , y )}{12}$$

wherein S is the new computed pixel intensity, I is the pixel intensity to be remapped and xMin and xMax are the minimum and maximum surrounding pixel intensities of each pixel with a suprathreshold W.

In order to avoid any artifacts due to a sudden change in image sharpness, the intensity computed with the logistic function is blended with the original pixel intensity using the following equation, Equation (16):

V(x, y)=\sqrt{W(x, y)}*S(x, y)+(1−\sqrt{W(x, y)})*I(x, y) (16)

wherein V is the final pixel value, W is the weighting factor, S is the intensity computed by the logistic function and I is the unsharpened image intensity. This processing results in a sharpened Y channel image, indicated at box 242.

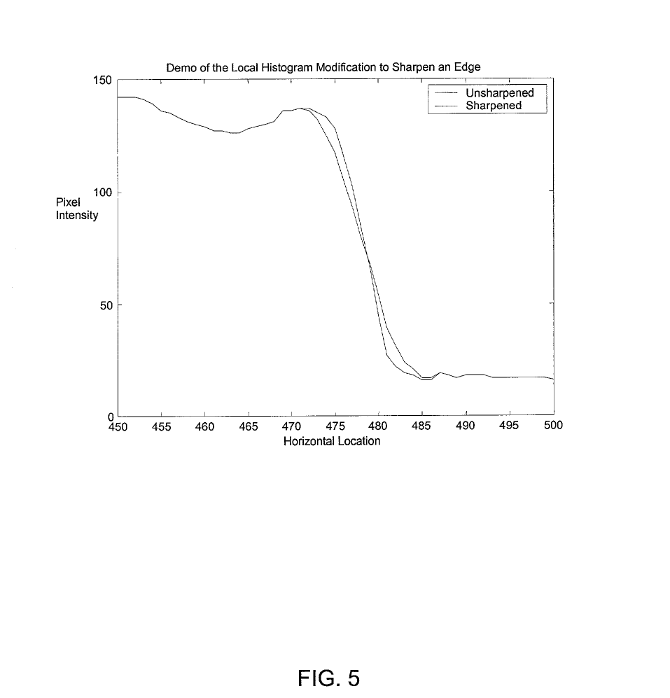

FIG. 5 demonstrates the effect of sharpening in this manner. It shows the pixel intensity values for a horizontal slice through a high contrast edge of a digital photograph that has been enlarged by a factor of six in each direction. There is an increase in the edge slope and no pixels beyond the edge have been altered.

The image resulting from the preferred embodiment of this invention is ten converted back to RGB representation, indicated at box 244, and the image padding added initially at box 204 can be removed at box 246. The resized output image produced from the operations described above has sharp high contrast edges, with minimal apparent artifacts.

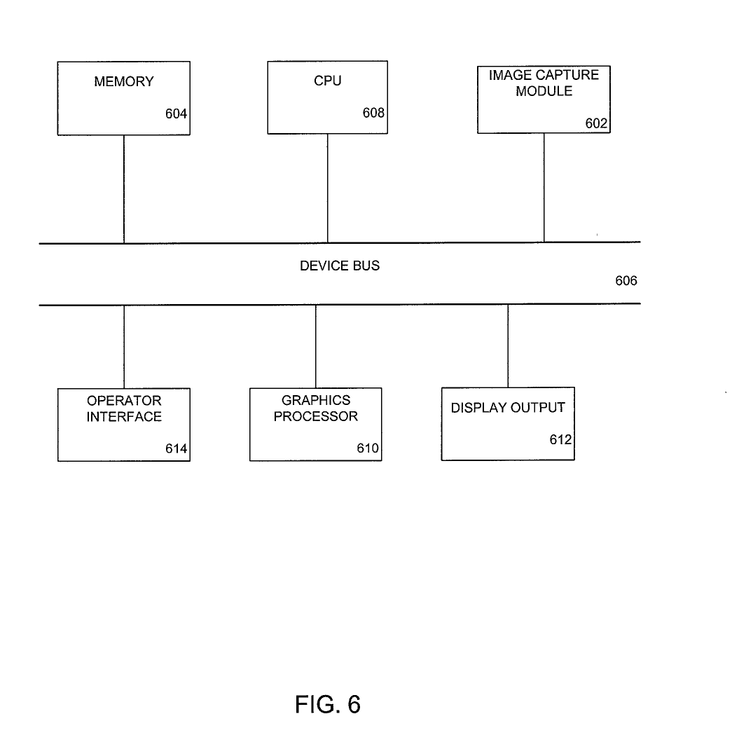

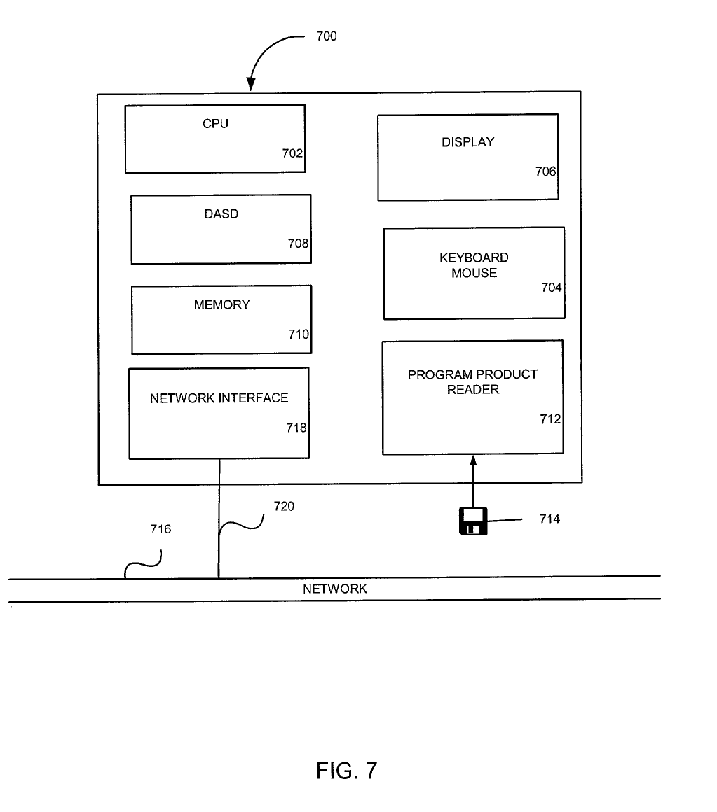

The processing described above in accordance with the invention may be performed in an image capture device or any computing device with user input and a suitable associated display, such as a video display (CRT) device, flat panel display, or printer. FIG. 6 is a block diagram representation of an image capture device constructed in accordance with the present invention. FIG. 7 is a block diagram representation of a computing device constructed in accordance with the present invention.

Image Capture Device

FIG. 6 shows a digital camera 600 or other similar image capture device that incorporates image processing operations in accordance with the present invention. The camera includes an image capture module 602 that may comprise an optical lens and capture array, such as a CCD array. The module provides its output to an image memory 604 over a system bus 606 for temporary storage, operating under control of a central processing unit (CPU) 608. The image data may be retrieved from memory and provided to a graphics processor 610, which processes the image data in accordance with the description above. The graphics processor may comprise the CPU operating to process pixel data or may be a dedicated graphics processor. The memory 604 may be partitioned or managed by the CPU to have segments comprising buffers for temporarily storing the image data, coefficients, and the like.

The processing results may be observed by a user via a display output device 612, such as an LCD screen or an output port connection to a printer or other display device. An operator interface 614 is used to receive user commands, such as specifying enlargement ratios or other processing choices. The memory 604 may receive image data from external stores, such as flash memory devices used in conjunction with the digital camera, or may receive the image data from other data sources associated with the digital camera.

Computer Construction

The image processing in accordance with FIG. 1 and FIG. 2 above may be implemented in a computer device, such as a personal computer, or any other of a variety of processing devices, such as a handheld computing device, a Personal Digital Assistant (PDA), and any conventional computer suitable for implementing the functionality described herein.

FIG. 7 is a block diagram of an exemplary computer device 700 such as might comprise a graphics image processor that implements the operation described in FIG. 1 or FIG. 2. The computer 700 operates under control of a central processor unit (CPU) 702, such as an application specific integrated circuit (ASIC) from a number of vendors, or a “Pentium”-class microprocessor and associated integrated circuit chips, available from Intel Corporation of Santa Clara, Calif., USA. Commands and data can be input from a user control panel, remote control device, or a keyboard and mouse combination 704 and inputs and output can be viewed at a display 706. The display is typically a video monitor or flat panel display device.

The computer device 700 may comprise a personal computer or, in the case of a networked client machine, the computer device may comprise a Web appliance or other suitable network communications device. In the case of a personal computer, the device 700 preferably includes a direct access storage device (DASD) 708, such as a fixed hard disk drive (HDD). The memory 710 typically comprises volatile semiconductor random access memory (RAM). If the computer device 700 is a personal computer, it preferably includes a program product reader 712 that accepts a program product storage device 714, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, a DVD disk, or the like. Semiconductor memory devices for data storage and corresponding readers may also be used. The computer device 700 can optionally communicate with other computers over a network, though the image processing operations in accordance with the present invention do not depend on any networked communications. If the computer 700 is networked, then the computer can communicate with the other connected computers over a network 716 (such as the Internet) through a network interface 718 that enables communication over a connection 720 between the network and the computer device.

The CPU 702 operates under control of programming steps that are temporarily stored in the memory 710 of the computer 700. When the programming steps are executed, the pertinent system component performs its functions. Thus, the programming steps implement the image processing operations described in accordance with FIG. 1 and FIG. 2. The programming steps can be received from the DASD 708, through the program product 714, or through the network connection 720, or can be incorporated into an ASIC as part of the production process for the computer device. If the computer device includes a storage drive 712, then it can receive a program product, read programming steps recorded thereon, and transfer the programming steps into the memory 710 for execution by the CPU 702. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 710 over the network 716. In the network method, the computer receives data including program steps into the memory 710 through the network interface 718 after network communication has been established over the network connection 720 by well-known methods that will be understood by those skilled in the art without further explanation. The program steps are then executed by the CPU 702 to implement the processing of the system.

The memory 710 may be partitioned or managed by the CPU or other memory controller to have segments comprising one or more buffers for temporarily storing the image data. Alternatively, the memory may include other forms of data storage that provide the necessary data buffers and storage for implementing the processing described above.

The present invention has been described with reference to the specific embodiments above so that an understanding of the present invention can be conveyed. It should be understood, however, that various changes may be made and equivalents may be substituted without departing from the true spirit and scope of the invention. In addition, many modifications (for example, operating steps) may be made to adapt to a particular situation. The present invention should therefore not be seen as limited to the particular embodiments described herein, but rather, it should be understood that the present invention has wide applicability with respect to image processing generally. All modifications, variations, or equivalent arrangements and implementations that are within the scope of the claims should therefore be considered within the scope of the invention.

1. A computer method of producing an resized output image from an original input image comprising digital pixel data, the method comprising:
(a) computing an approximated image using a two-dimensional approximation technique applied to the digital pixel data of the original input image;
(b) determining a residual image;
(c) determining a weighting factor for each pixel of the approximated image; and
(d) selectively adding residual image data into the approximated image in accordance with the weighting factor for each resized output image pixel.

2. A method as defined in claim 1, further including resizing the residual image to a resolution equal to that of the resized output image.

3. A method as defined in claim 1, wherein selectively adding residual image data comprises adding a fraction of the value of each residual image pixel to the corresponding pixel value in the approximated image based on the corresponding weighting factor.

4. A method as defined in claim 1, wherein the two-dimensional approximation method is a least-squares method.

5. A method as defined in claim 4, wherein the two-dimensional approximation technique comprises a least-squares technique wherein the original image is convolved with convolution kernels.

6. A method as defined in claim 5, wherein the convolution kernels are pre-computed and stored in a memory buffer.

7. A method as defined in claim 1, wherein the residual image is determined by subtracting each original image pixel intensity value from its corresponding pixel point in the approximated image.

8. A method as defined in claim 1, wherein each weighting factor is computed based on local image characteristics of the original image.

9. A method as defined in claim 1, wherein each weighting factor is computed from a luminance channel and the same weighting factor values are used for all channels associated with the image.

10. A method as defined in claim 1, wherein each weighting factor is determined in accordance with a local gaussian curvature value for the corresponding pixel.

11. A method as defined in claim 1, wherein each weighting factor is determined in accordance with a local gaussian curvature value and a local image gradient for the corresponding pixel.

12. A method as defined in claim 1, further comprising sharpening the resized output image, wherein sharpening the resized output image comprises:
(a) computing a gradient image for the original input image;
(b) extrapolating the intensity of each resized image pixel away from a blurred version of the resized image, wherein the extrapolation is performed in accordance with a corresponding gradient value, thereby producing a sharpened image;
(c) for each pixel in the unsharpened image, searching the image area surrounding the pixel and finding the maximum and minimum pixel intensity value in the searched area, wherein the size of the area to be searched is a function of the resolution factor of the resized output image in comparison with the original input image; and
(d) for each pixel in the sharpened image produced in (b), comparing the intensity value of a sharpened image pixel to the corresponding maximum and minimum intensity values found in pixels of the unsharpened image from (c) and modifying the intensity value of the sharpened image pixel in response to the comparison.

13. A method as defined in claim 12, wherein modifying the sharpened intensity value in 12(d) comprises:
identifying when the value of the sharpened pixel is outside the range of the maximum and the minimum intensity values found in the unsharpened image from 12(c); and
modifying the sharpened intensity value to be closer to the nearer of the maximum or the minimum found intensity values.

14. A method as defined in claim 12, wherein modifying the sharpened value in 12(d) comprises:
identifying when the value of the sharpened pixel is greater than the maximum intensity value; and
modifying the sharpened pixel intensity value to a value given by F(x, y), wherein F(x, y) is specified according to the relationship
F(x, y)=max(x, y)+a* [S(x, y)−max(x, y)],
wherein F(x, y) is the final sharpened pixel intensity value, max(x, y) is the maximum intensity value found for that pixel location, a is a value that specifies the fraction of the overshoot to allow, and S(x, y) is the value of the sharpened pixel intensity.

15. A method as defined in claim 12, wherein modifying the sharpened value in 12(d) comprises:
identifying when the value of the sharpened pixel is less than the minimum intensity value; and
modifying the sharpened pixel intensity value to a value given by F(x, y), wherein F(x, y) is specified according to the relationship
F(x, y)=min(x, y)+a* [min(x, y)−S(x, y)],
wherein F(x, y) is the final sharpened pixel intensity value, min(x, y) is the minimum intensity value found for that pixel location, a is a value that specifies the fraction of the overshoot to allow, and S(x, y) is the value of the sharpened pixel intensity.

16. A method as defined in claim 12, wherein the blurred version is obtained by computing a blurred version of the input image where the amount of blur depends on the resizing factor of the output image.

17. A method as defined in claim 12, wherein the gradient image is resized to the size of the output image.

18. A method as defined in claim 12, wherein each pixel value in the gradient image is mapped to a new extrapolation factor in accordance with a lookup table.

19. A method as defined in claim 12, wherein only the luminance channel is sharpened.

20. A method as defined in claim 1, further comprising sharpening the image produced, wherein sharpening comprises:
(a) locating pixels in the resized output image that are likely to be part of a high contrast continuous edge by comparing the output of an edge detector function with a threshold value; and
(b) for any pixel found to be part of a high contrast continuous edge, searching an area around the pixel to be processed, where the size of the search area is a function of the resizing factor of the output image, and finding the maximum and minimum intensity values of the pixels in the search area;
(c) using a non-linear but continuous function, computing a sharpened pixel value that is closer to the nearer of the maximum or minimum value found in 12(b); and
(d) computing a final pixel value by combining the sharpened pixel value with the unprocessed pixel value, using the output of the edge detector function to control the amount of sharpening.

21. A method as defined in claim 16, wherein only other-edge pixels within the search area are searched for maximum and minimum intensity values in accordance with the searching operation of 20(b).

22. A method as defined in claim 20, wherein only the luminance channel is sharpened.

23. A method as defined in claim 20, wherein the nonlinear but continuous function to compute a sharpened pixel value is a logistic function, calculated according to the following equation:
$$S ( x , y ) = x Min ( x , y ) + a * \frac{1}{1 + {ⅇ}^{\frac{I ( x , y ) - Mid}{B}}}$$
$$where Mid = \frac{x Max ( x , y ) + x Min ( x , y )}{2}$$
$$a = x Max ( x , y ) - x Min ( x , y )$$
$$B = \frac{x Max ( x , y ) - x Min ( x , y )}{12}$$
where xMax(x, y) and xMin(x, y) are the local maximum and minimum values found in 18(b), S(x, y) is the sharpened pixel value, and I(x, y) is the unsharpened pixel value.

24. A method of suppressing overshoots or undershoots resulting from sharpening an original image comprised of digital pixel data comprising:
(a) sharpening the original input image;
(b) for each pixel in the original input image (unsharpened) finding the maximum and minimum pixel intensity value in an area surrounding the pixel, wherein the area to be searched covers the range of any overshoot or undershoot due to the sharpening method;
(c) for each sharpened pixel, comparing the intensity value of the sharpened pixel to the corresponding maximum and minimum values found in (b) and if the value of the sharpened pixel is outside the range of said maximum and the minimum, modifying the sharpened value to be closer to or equal to the nearer of the maximum or the minimum.

25. A method as defined in claim 24, wherein the sharpening method is unsharp masking.

26. A method as defined in claim 24, wherein the sharpening method is unsharp masking and the amount of unsharp masking applied at each pixel varies as a function of the local image gradient in the original image.

27. A method as defined in claim 24, wherein said sharpening method is applied only to a luminance channel of the original image.

28. A method of sharpening an original image of digital pixel data, the method comprising:
(a) determining the pixels in the original input image to be sharpened;
(b) for any pixel to be sharpened, searching an area around the pixel to be processed in the original input image for the maximum and minimum pixel values; and
(c) using a non-linear but continuous function, computing a sharpened pixel value that is closer to the nearer of the maximum or minimum value found in (b) for each pixel.

29. A method as defined in claim 28, wherein the pixels in the original image to be sharpened are those found to be part of continuous edges.

30. A method as defined in claim 28, wherein only other pixels to be sharpened within the search area are searched for maximum and minimum intensity values.

31. A method as defined in claim 28, wherein the final sharpened pixel value is computed by combining the sharpened value with the original image pixel value using local image characteristics to determine the weighting of the sharpened pixel value.

32. A method as defined in claim 28, wherein said sharpening method is applied only to a luminance channel of the original image.

33. A method as defined in claim 28, wherein the nonlinear but continuous function to compute a sharpened pixel value is a logistic function, calculated according to the following equation:
$$S ( x , y ) = x Min ( x , y ) + a * \frac{1}{1 + {ⅇ}^{\frac{I ( x , y ) - Mid}{B}}}$$
$$where Mid = \frac{x Max ( x , y ) + x Min ( x , y )}{2}$$
$$a = x Max ( x , y ) - x Min ( x , y )$$
$$B = \frac{x Max ( x , y ) - x Min ( x , y )}{12}$$
where xMax(x, y) and xMin(x, y) are the local maximum and minimum values, S(x, y) is the sharpened pixel value, and I(x, y) is the unsharpened pixel value.

34. A method of distinguishing between texture, continuous edges, and smooth regions in an image of digital pixel data using local gaussian curvature in the image, the method comprising:
(a) computing the gaussian curvature at each pixel location; and
(b) determining pixels within the image that are likely to be texture, in accordance with the computed gaussian curvature and processing such that high gaussian curvature indicates texture and not continuous edges or smooth regions.

35. A method as defined in claim 34, wherein the pixel intensity values are scaled to make them compatible with the spatial pixel size for the gaussian curvature calculation.

36. A method as defined in claim 34, wherein the range of gaussian curvature values is compressed by using the logarithm of the gaussian curvature values.

37. A method as defined in claim 34, wherein the gaussian curvature values are blurred prior to categorizing pixels.

38. A method as defined in claim 34, wherein both the gaussian curvature and the local image gradient are used to distinguish between texture and continuous edges comprising:
(a) computing the gaussian curvature at each pixel location;
(b) computing the local image gradient at each pixel location; and
(c) categorizing pixels as part of a continuous edge, a texture region, or a smooth region, in response to processing such that pixel values with large gradients but small gaussian curvature values are characterized as part of a continuous edge, pixels with large gradients and large gaussian curvatures are characterized as part of a texture region, and pixels with small gradients and small gaussian curvatures are characterized as part of a smooth region.

39. A method as defined in claim 34, wherein the ratio of a function of the gaussian curvature to a function of the gradient at each pixel is used to distinguish between texture and continuous edges using the rule that small values indicate continuous edges.

40. An apparatus that processes digital image data, the apparatus comprising:
a memory; and
a processor that receives the digital image data, comprising pixel data that defines an original input image, from the memory and produces an enlarged image corresponding to the input image by computing an approximated image using a two-dimensional approximation technique applied to the digital pixel data of the original input image, determining a residual image, determining a weighting factor for each pixel of the approximated image, and selectively adding residual image data into the approximated image in accordance with the weighting factor for each enlarged output image pixel.

41. An apparatus that processes digital image data, the apparatus comprising:
a memory; and
a processor that receives the digital image data, comprising pixel data that defines an original input image, from the memory and suppresses overshoots or undershoots by sharpening the original input image, for each pixel in the original input image (unsharpened) finding the maximum and minimum pixel intensity value in an area surrounding the pixel, wherein the area to be searched covers the range of any overshoot or undershoot due to the sharpening method, for each sharpened pixel, comparing the intensity value of the sharpened pixel to the corresponding maximum and minimum values and, if the value of the sharpened pixel is outside the range of said maximum and the minimum, modifying the sharpened value to be closer to or equal to the nearer of the maximum or the minimum.

42. A digital image processing apparatus for processing a digital input image into an output image, the apparatus comprising:
an input buffer that stores pixel data of the input image;
locating means for locating a local position with the input image for interpolation;
approximated image means for obtaining a first approximated output image pixel at a predetermined pixel position in an approximated output image;
residual image means for obtaining a residual image pixel at the predetermined pixel position;
means for deriving an input image characteristic value from the input image pixel data; and
means for calculating a resultant output image pixel at the predetermined position in the output image by combining the approximated and residual image pixels as a function of the input image characteristic value.

43. An apparatus according to claim 42, wherein each pixel of the resultant output image is calculated according to the relationship:
p=X+(S)Y
where:
P represents the resultant output image pixel;
X represents the approximated output image pixel;
Y represents the residual image pixel; and
S represents a scaling factor, with a value of from 0 to 1, derived from the input image characteristic value.

44. An apparatus according to claim 42, wherein the means for deriving an input image characteristic is adapted to derive values for continuous edges.
